(19) United States
(12) Patent Application Publication
(10) Pub. No.: US 2017/0033361 A1
(43) Pub. Date: Feb. 2, 2017

(54) PHOSPHATE BASED COMPOUND, USE OF THE COMPOUND IN AN ELECTROCHEMICAL STORAGE DEVICE AND METHODS FOR ITS PREPARATION

(71) Applicant: MAX-PLANCK-GESELLSCHAFT ZUR FOERDERUNG DER WISSENSCHAFTEN E.V., MUENCHEN (DE)

(72) Inventors: CHRISTOPH KALLFASS, SCHWAEBISCH HALL (DE); HERMANN SCHIER, STUTTGART (DE); HELMUT SCHUBERT, BERLIN (DE)

(73) Assignee: MAX-PLANCK-GESELLSCHAFT ZUR FOERDERUNG DER WISSENSCHAFTEN E.V., MUENCHEN (DE)

(21) Appl. No.: 15/295,663

(22) Filed: Oct. 17, 2016

Related U.S. Application Data
(62) Division of application No. 13/139,036, filed on Nov. 18, 2011.

(30) Foreign Application Priority Data
Dec. 12, 2008 (EP) 08021669.0

(51) Int. Cl. H01M 4/58; C01B 25/45

(52) U.S. Cl. CPC H01M 4/5825; C01B 25/45; C01P 2006/40; H01M 2004/027

(57) ABSTRACT

A phosphate based compound basically comprising —A: exchangeable cations used in charging and discharging, e.g. Li, Na, K, Ag, —B: non-exchangeable cations from the transition metals, group 3-12 of the periodic table of elements, e.g. Fe, Mn, Co, Cr, Ti, V, Cu, Sc, —C: 60 Mol-%-90 Mol-%, preferably 75 Mol-% of the compound being phosphate (PO₄)³⁻ anions, where oxygen is or may be partially substituted by a halide (e.g. F, Cl) and/or OH⁻ to a maximum concentration of 10 Mol-% of the oxygen of the anions and wherein said (PO₄)³⁻ coordination polyhedra may be partially substituted by one or more of: SiO₄⁴ silicate, BO₃³⁻ borate, CO₃²⁻ carbonate, H₂O water up to a maximum amount of <31 Mol-% of the anions, said compound being in crystalline form and having open elongate channels extending through the unit cell of the structure and with the compound being present either in single crystal form or as an anisotropic microcrystalline or nanocrystalline material. The phosphate based compound is used as an electroactive material, for example as a cathode, an anode or a separator in an ion battery or electrochemical storage device or electrochemical cell.

### CROSS-REFERENCES TO RELATED APPLICATIONS

Not Applicable

### STATEMENT AS TO RIGHTS TO INVENTIONS MADE UNDER FEDERALLY SPONSORED RESEARCH AND DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

The present invention relates to a phosphate based compound having a novel structure and suitable, amongst other things, for use as an electrode material such as a cathode or an anode or as an electroactive material in a primary or secondary battery or in another type of electrochemical storage device or electrochemical cell and also to methods of preparing such a material.

In the last eleven years the material LiFePO₄, an ortho-phosphate, has adopted a central position in the research, development and optimization of new cathode materials, in particular for use in lithium ion batteries. The first description of the electrical properties of this synthetically manufactured ortho-phosphate dates from the year 1997 and was the starting point for rapid development, to the extent that it is nowadays a preferred cathode material used in lithium-ion batteries. More recently it has been found that the naturally occurring mineral triphylite, with the simplified chemical formula LiFePO₄, is likewise suitable as a cathode material. This is described in the paper by Ravet, N., Chouinard, J., Besner, S., Gautier, M. Armand, M. entitled “Electroactivity of natural and synthetic triphylite” in the Journal of power sources, 97-98:503-507, 2001.

The LiFePO₄ materials used to date are isostructural to olivine.

Despite the extensive development work which has gone into the development of LiFePO₄ materials the commercially available versions still have many disadvantages and are far from satisfactory. Thus, there is a wide diversity of LiFePO₄ materials which do not have the same properties.

There is an ongoing endeavour to achieve ever more powerful battery materials with excellent chemical, electrical, mechanical and environmentally compatible characteristics such as are necessary for use in the most diverse technical communication apparatus and drive technologies.

The principal object underlying the present invention is to provide a new class of materials which are ideally suited for use as an electroactive material particularly in batteries, especially but not only in lithium ion batteries and also materials with excellent storage capacities for various types of ions. It is a further object to provide a new class of materials which is superior in many respects to LiFePO₄, not just in its physical, chemical and electrochemical properties but also with respect to its ease of manufacture, favourable cost and environmentally friendly properties.

In order to satisfy this object there is provided a phosphate based compound comprising:
A: exchangeable cations used in charging and discharging and being at least one of Li, Na, K and Ag,
   wherein up to 25 Mol-% of the compound may be present in each of the following categories:
   elements of Group 1 of the periodic table of elements,
   elements of Group 2 of the periodic table of elements,
   elements of Group 13 of the periodic table of elements,
   elements of the group of transition metals, group 3-12 of the periodic table of elements, e.g. Mn, Fe, Ag
   elements of Group 14 of the periodic table of elements, e.g. Pb
B: non-exchangeable cations from the transition metals, e.g. Fe, Mn, Co, Cr, Ti, V, Cu, Sc
   wherein 9 Mol-%-23 Mol-%, preferably 16 Mol-% of the compound may be present in each of the following categories:
   elements of Group 1 of the periodic table of elements,
   elements of Group 2 of the periodic table of elements,
   elements of Group 13 of the periodic table of elements,
   elements of the group of transition metals, group 3-12 of the periodic table of elements, e.g. Mn, Fe,
   elements of Group 14 of the periodic table of elements, e.g. Pb
C: 60 Mol-%-90 Mol-%, preferably 75 Mol-% of the compound being phosphate (PO₄)³⁻ anions where oxygen is or may be partially substituted by a halide (e.g. F, Cl) and/or OH— to a maximum concentration of 10 Mol-% of the oxygen of the anions,
   wherein said (PO₄)³⁻ anions may be partially substituted by one or more of:
      SiO₄⁴⁻ silicate,
      BO₃³⁻ borate,
      CO₃²⁻ carbonate,
      H₂O water up to a maximum amount of <31 Mol-% of the anions,
   said compound being in crystalline form and having elongate channels extending through the unit cell of the structure and
   with the compound being present either in single crystal form or as an anisotropic microcrystalline or nanocrystalline material.

The value of less than 31 Mol-% is selected because at 31 Mol-% the compound becomes unstable and for this reason values higher than 30 Mol-% should preferably not be selected.

The compound can additionally consist of at least one element selected from the group consisting of Group 2 of the periodic table of elements and aluminium. Aluminium is optional.

Moreover, the element selected from the group of transition metals can comprise at least one of Sc, Ti, V, Cr, Mn, Fe, Co, Ni, Cu and Zn. In the following text the expression “transition metal” is a synonym for the elements of Group 3-12 of the periodic table of elements (FIG. 9).

Some materials of the general class described above are known and are generally referred to as “Arrojadites”. In the following the term “Arrojadite” will be used as a generic term or synonym to describe the crystalline structure in accordance with the present invention. Arrojadites are known per se and seven different structure models have been described in five publications (as listed in FIG. 1).

These compositions are either naturally occurring forms of Arrojadite or synthetically prepared forms. Although their crystalline nature has been identified no-one has hitherto recognised that they include elongate channels extending through the respective unit cells from one side to the other, but are described as isolated parts of the framework or as vacancies.

These partially unoccupied lattice sites are usually described as mixed positions of at least two different ions, e.g. for Nickel Plate Arrojadite Fe and Al, which show up as a pseudo atom, e.g. “Cr³⁺”, with approximately the same electron density (24 electrons, taken from 92% Fe^{III} and 8% Al^{III}) in the structural model, data provided as Computer Interchange Format (CIF). The flexible occupations of the different sites offer the technical advantage of filling up these sites with a variety of mobile cations, e.g. Na, Li, K, Ag. In addition, if the split positions are divided between the cations and part of the framework C, the amount of exchangeable cations is even more enhanced.

One important recognition underlying the present invention is that the element or elements filling these elongate channels can readily be removed chemically or electrochemically to form open elongate channels which can subsequently be used to accommodate and reversibly store ions such as Li, Na, K and/or Ag thus making the materials particularly suitable for use as a cathode material in an Li, Na, K or Ag based battery.

Thus the material of the invention can be readily used an electroactive material in the form of an electrode material such as a cathode or anode for a primary or secondary battery or in another form of electrochemical storage device such as a supercapacitor. It can also be used generally as an electroactive material e.g. as a semipermeable membrane used as separator in electrochemical cells or battery.

The material is particularly beneficial when used in an electrochemical storage device because a relatively large amount of the relevant ions can be stored resulting in a high exploitable electrical capacity, which can certainly be increased when the new material has been fully developed. Moreover, the material is dimensionally and chemically stable. Thus there is virtually no change in size of the electrode material when the battery is charged or discharged so that the battery or electrochemical storage device does not suffer mechanical damage due to size changes during the work cycles and has a long working life. Moreover, the fact that there is no chemical change in the structural framework involved during the storage, removal or transport of the relevant ions means that the charge capacity and particularly the useful charge capacity is maintained over very many cycles. This has already been proved experimentally over 5000 charge and discharge cycles and there is no reason why the number of cycles should be limited. This is in stark contrast to other cathode materials, e.g. LiFePO₄, where chemical and structural changes take place during charging and discharging cycles resulting in a significant and progressive reduction in the useful charge capacity from the first charge/discharge cycle onwards.

When used in a lithium battery, the element selected for the exchangeable cations is Li or, when used in a sodium battery, the element selected for the exchangeable cations is Na or, when used in a potassium battery the element selected for the exchangeable cations is K or when used in a silver battery, the element selected for the exchangeable cations is Ag.

The material of the invention is not however restricted to use as an electrode in a battery or supercapacitor, it can for example, as suggested earlier in this specification, also be used as a semipermeable membrane for a separator in a battery with the elongate channels serving as a transport passage for the relevant conductive ions or, alternatively, as an ion exchange material, for example in chromatography.

Thus the invention also relates to an electrochemical storage device comprising an electrode formed of a phosphate based compound as described above and to a separator formed from such a phosphate based compound

The phosphate based compound of the present invention can be prepared, by a method comprising the steps of:
removing from the earth in a suitable location, e.g. the Nickel Plate mine in South Dakota, USA or the Hagendorf mine in the Oberpfalz, Bavaria, Germany, a naturally occurring compound having the chemical composition of any one of claims 1 to 3 together with impurities,
purification of the naturally occurring compound to remove the impurities, and
chemically treating the naturally occurring compound, preferably after purification, to remove, so far as possible, exchangeable cations of the type A and the naturally occurring impurities to open up the elongate channels extending through the unit cell of the structure, i.e. to unload or clean them and leave open elongate channels.

The cleaning process can, for example, comprise a flotation process.

It will be appreciated that these processes are very straightforward and can be readily carried out on a large scale and in an environmentally friendly manner so that a favourably priced product can be realised.

In this case, the cleaned compound is chemically treated to remove the exchangeable cation or cations, i.e. Li, Na, K, Ca, Mg, Sr, Al, Fe, Mn, Zn and/or Ag to unload the structure and leave open elongate channels extending through the unit cell of the structure.

The chemical treatment step is conveniently carried out using a complexing agent such as EDTA (2-[2-(Bis(carboxymethyl)amino)ethyl-(carboxymethyl)amino]acetic acid), pentan-2,4-dione (acetyl-acetone),crown-ethers e.g. 18-crown-6 or 1,5-diphenylthiocarbazone (dithiozone). EDTA is particularly favoured as it is a water based and thus environmentally particularly friendly compound.

The method of preparation can also include the further step of at least partially filling the elongate channels with an active element selected from Group 1 of the periodic table of elements and/or Ag. This can, for example, be carried out by immersing said compound in a salt melt, by suspension or electrochemically.

As an alternative to mining the phosphate based compound in accordance with the present invention can also be synthesised, for example using the method proposed by O. V. Yakubovich, E. N. Matvienko, M. A. Simonov and O. K. Mel'nikov in the publication entitled “Crystal Structure of Synthetic Fe³⁺-Arrojadite with ideal formula of K₂Na₅Fe²⁺₁₄Fe³⁺(PO₄)12(OH)₂”, Vestnik Moskovskogo Universiteta, Geologiya, Vol. 41, No. 1, pages 36-47, 1986.

That is to say the phosphate based compound of the present invention can be synthesised by hydrothermal synthesis, carried out using:
B: non-exchangeable cations, e.g. in the form of an oxide of one or more transition metals, e.g. Fe₂O₃
C: anions in the form of a phosphate, e.g. (NH4)₂HPO₄ or (Na,K)₂HPO₄,
A: exchangeable cations as a soluble salt of one of Li, Na, K and Ag, e.g. KCl, the method being carried out in a pressure vessel in the presence of water in a temperature range of 300° C.-600° C., e.g. 450° C., with the initial concentration of the aqueous solution being selected so that the concentration of A cations, e.g. KCl amounts to 30-70 wt %, preferably to about 50 wt % and with CsCl being present in an mount of 70-30 wt %, preferably e.g. 50 wt %.

After the synthesis has been completed the material of the invention is present as a crystalline material in an aqueous solution which can be removed leaving the crystalline product with the elongate channels filled with type A cations such as Li, Na, K and/or Ag.

In this case, the synthesised compound is made by synthesis and is not chemically treated to remove the exchangeable cation or cations, because the exchangeable ions are provided directly during the hydrothermal synthesis. The amount of lattice sites for exchangeable cations is highest for the synthetic compound and differs amongst the naturally occurring minerals, e.g. from Nickel Plate and Hagendorf.

### BRIEF SUMMARY OF THE INVENTION

### BRIEF DESCRIPTION OF THE DRAWINGS

The invention will now be described in more detail with reference to the accompanying drawings especially with reference to use of the invention as a cathode material in a lithium ion battery and with the properties of the new material and its preparation being contrasted with that of LiFePO₄, currently one of the most promising cathode materials for commercial use in the near future. In the drawings there are shown:

FIG. 1 a table showing the articles dealing with the different crystal models for Arrojadites, which are published in the Inorganic Single Crystal Database (ICSD),

FIGS. 2A to 2E are representations of the unit cell of an Arrojadite crystal in accordance with the present invention as seen in the direction of the a-axis (FIG. 2A), c-axis (FIG. 2B) and b-axis (FIG. 2C), with the coordination polyhedra of the type A-cations being shown with lined hatching, with the framework of the type B-cations being shown with squared hatching and with the framework of the type C-anions being shown in white, with FIG. 2D showing the same view as FIG. 2C but presenting only the framework of type B cations building up the channels and omitting all other components for the sake of clarity and with FIG. 2E presenting the same view as FIG. 2C but as an artistic impression of the unit cell in three dimensions when viewed along the b-axis, with the elongate channels being shown as approximately black cylinders, although the open channels are not of strictly cylindrical shape,

FIGS. 3A, 3B and 3C flow diagrams illustrating the manufacture of an Arrojadite material in accordance with the present invention from a mined material and by synthesis (FIGS. 3A and 3B) in contrast to the manufacture of LiFePO₄ (FIG. 3C),

FIGS. 4A and 4B diagrams showing the reversible heat cycle of Arrojadite (FIG. 4A) and the decomposition of LiFePO₄ (FIG. 4B) when heated in air,

FIGS. 5A and 5B diagrams showing the reversible heat cycle of Arrojadite (FIG. 5A) and the decomposition of LiFePO₄ (FIG. 5B) when heated in a nitrogen atmosphere,

FIG. 6 a representation of the unit cell of the prior art material LiFePO₄ as seen in the direction of the b-axis for comparison purposes, with the coordination polyhedra of Li⁺ being shown with lined hatching, with the coordination polyhedra of Fe2⁺ being shown with squared hatching and with the coordination polyhedra of (PO₄)³⁻ being shown in white,

FIG. 7 changes in powder patterns of Arrojadite samples in dependence on the stirring time in 0.01M EDTA solution using Cu_{K}α₁ radiation for recording the powder patterns of the samples Oh, 2 h, 21 h, 90 h, and 189 h, these being respectively shifted by 1000 relative intensity units relative to the respectively preceding powder pattern for the sake of clarity,

FIG. 8 a table showing the lattice parameters of LiFePO₄ and FePO₄ at T=293K.

FIG. 9 the Periodic Table of the Elements, IUPAC version 22 Jun. 2007 as referred to herein,

FIG. 10 a schematic view of a lithium ion battery and

FIG. 11 an alternative schematic view of a lithium ion battery.

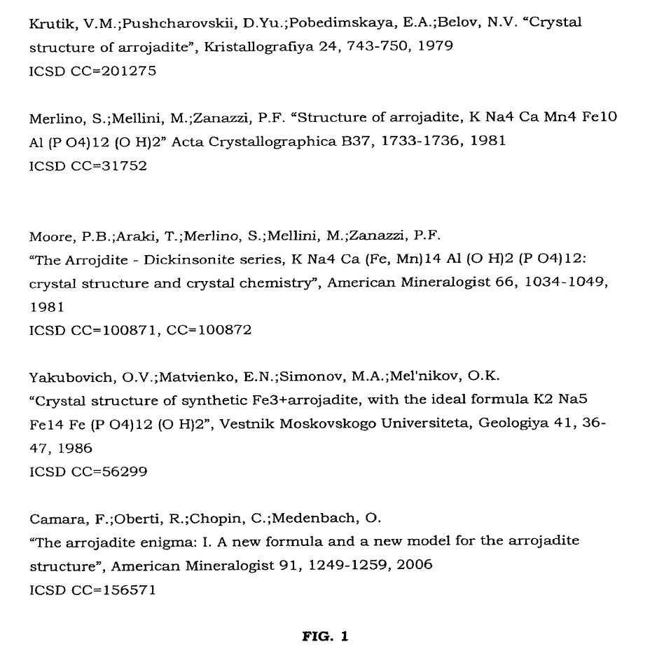

### DETAILED DESCRIPTION OF THE INVENTION

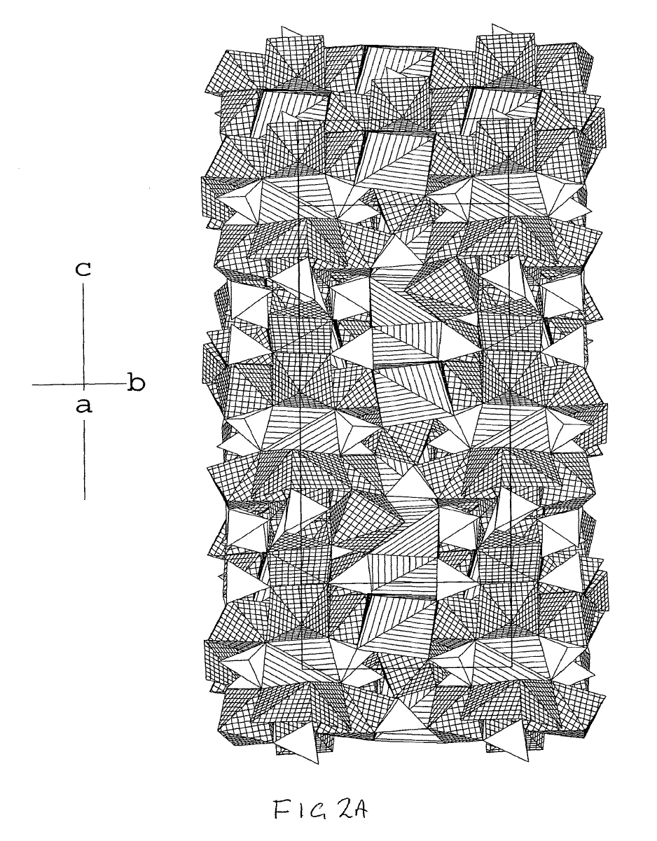

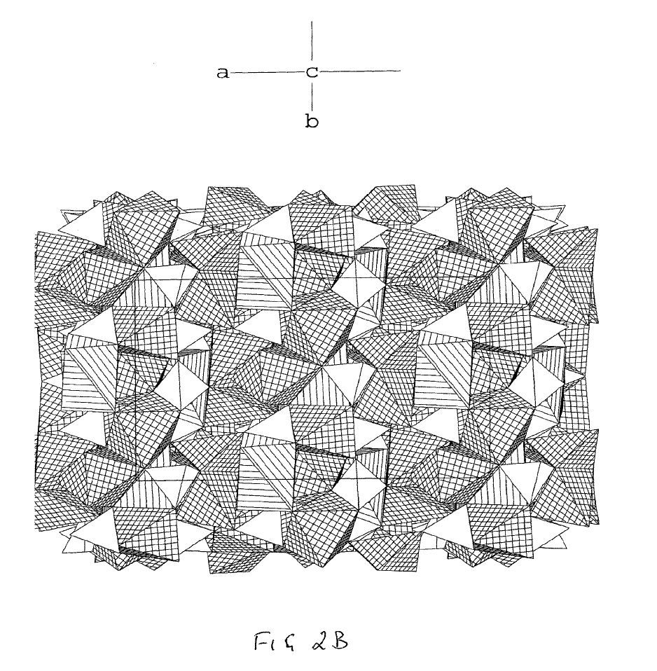

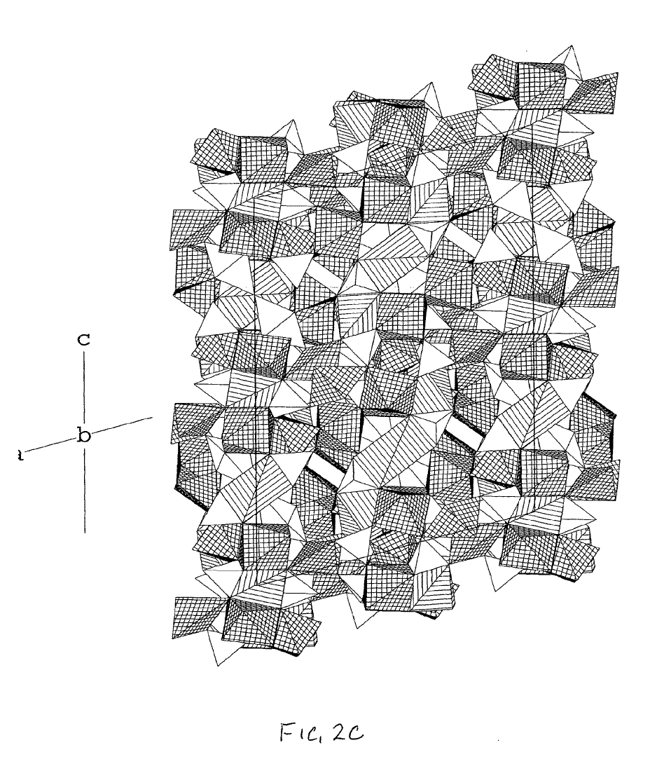

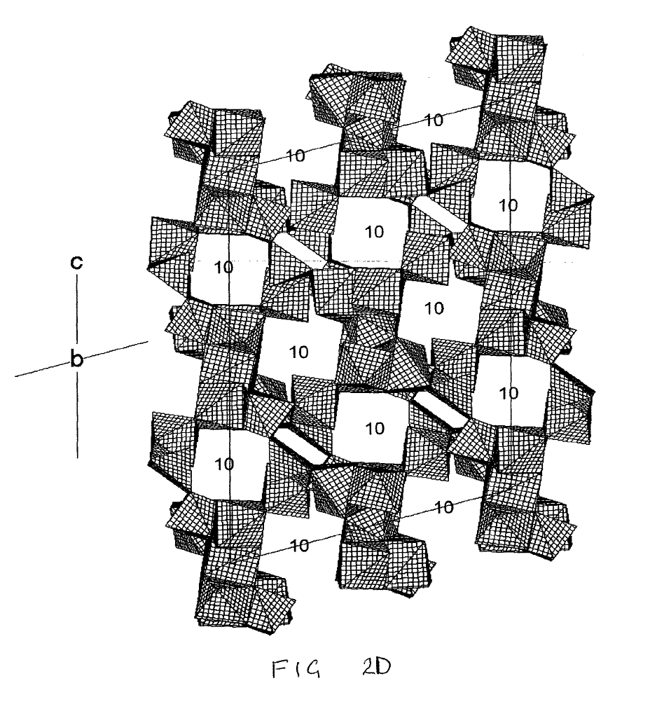

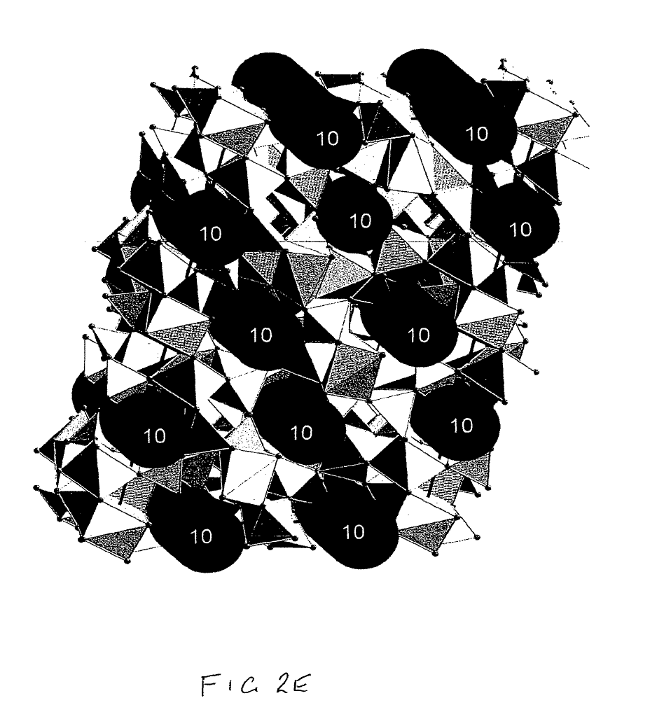

FIGS. 2A to 2C now show a typical unit cell for a naturally occurring Arrojadite crystal from Nickel Plate, a phosphate based compound of the following formula:
A: exchangeable cations used in charging and discharging, in this case Li, Na, K, Ag,
   wherein 10.13 Mol-% of the compound is present in each of the following categories:
   the following elements of Group 1 of the periodic table of elements: Li 0.57 Mol-%, Na 5.83 Mol-%, K 1.26 Mol-%,
   the following elements of Group 2 of the periodic table of elements: Mg 1.13 Mol-%, Ca 1.14 Mol-%, Sr 0.02 Mol-%, Ba 0.01 Mol-%,
   the following elements of the group of transition metals: Fe 2.9 Mol-%, Zn 0.14 Mol-%, Mn traces,
   the following element of Group 13 of the periodic table of elements: Al 0.09 Mol-°/0,
   the following element of Group 14 of the periodic table of elements: Pb 0.03
B: non-exchangeable cations from the transition metals in this case Fe, Mn, Co, Cr, Ti, V, Cu, Sc
   wherein 16.4 Mol-% of the compound is present in each of the following categories:
   traces of the following elements of Group 1 of the periodic table of elements: e.g. Li
   traces of the following elements of Group 2 of the periodic table of elements: e.g. Mg, Ca:
   the following elements of the group of transition metals: Fe 7.16 Mol-%, Mn 5.13 Mol-%, Ti 0.01 Mol-%, Zn traces,
   the following elements of Group 13 of the periodic table of elements: Al 1.13 Mol-%,
   the following elements of Group 1₄ of the periodic table of elements: Pb traces
C: anions, with 73.45 Mol-% of the compound being anionic in the form of phosphate (PO₄)³⁻ where oxygen is partially substituted by halide, e.g. F, Cl⁻ and/or OH⁻ to a maximum concentration of 10 Mol-% of the oxygen of the anions,
   wherein said (PO₄)3- anions are partially substituted by one or more of:
      traces of SiO₄⁴⁻ silicate,
      traces of BO₃³⁻ borate,
      traces of CO₃²⁻ carbonate,
      H₂O water 2.4 Mol-%
      in respective amounts of 3.27 Mol-% of the anions.

The compound is present in crystalline form and has elongate channels extending through the unit cell of the structure. It is present here in an anisotropic microcrystalline form.

The individual coordination polyhedra are identified in the figures by different hatching of the coordination polyhedra. FIG. 2D shows the same view as FIG. 2C but presents only the framework of type B cations building up the channels and omits all other components for the sake of clarity. FIG. 2E presents the same view as FIG. 2C but as an artistic impression of the unit cell in three dimensions when viewed along the b-axis, with the elongate channels 10 being shown as approximately black cylinders passing through the unit cell in the direction of the b-axis. Thus FIG. 2E shows a three-dimensional artist's representation of the unit cell of FIGS. 2A to 2C which has been shaded to show the presence of elongate channels 10 passing through the unit cell in the direction of the b-axis.

It should be emphasised here that the Arrojadite material of the present invention can be present in the form of single crystal material, in which case the channels 10 extend right through the single crystal (other than at any dislocations which may be present). It is however by no means necessary for the Arrojadite material to be present in single crystal form. Instead it can be present in microcrystalline, 500 μm-1 μm, or nanocrystal-line, 1 μm-0.001 μm, form and indeed will normally be present as a powder optionally together with a suitable binder such as poly-vinyl-difluoride (PVDF).

When the powder, for example produced by grinding, is pressed into tablet or film form a certain reorientation of the individual small crystals takes place so that the channels 10 tend to be aligned.

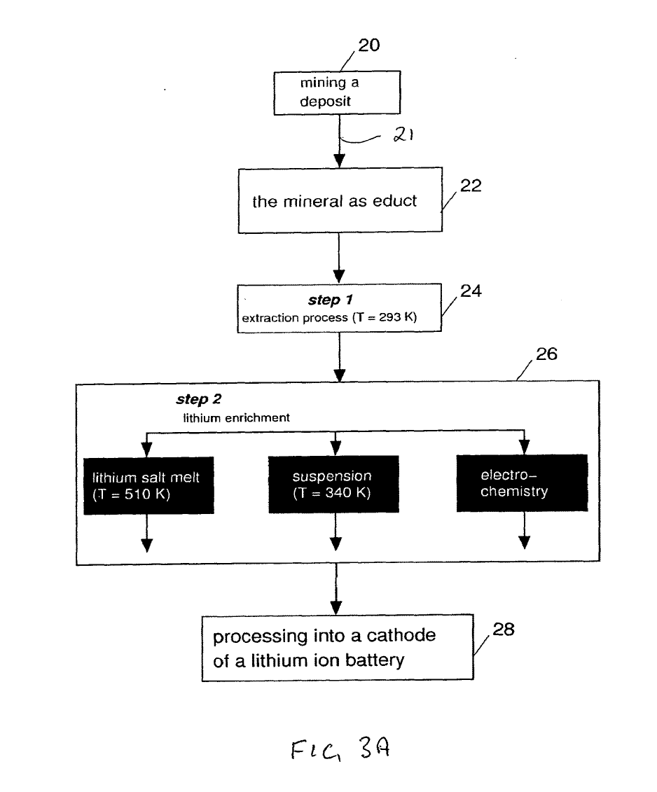

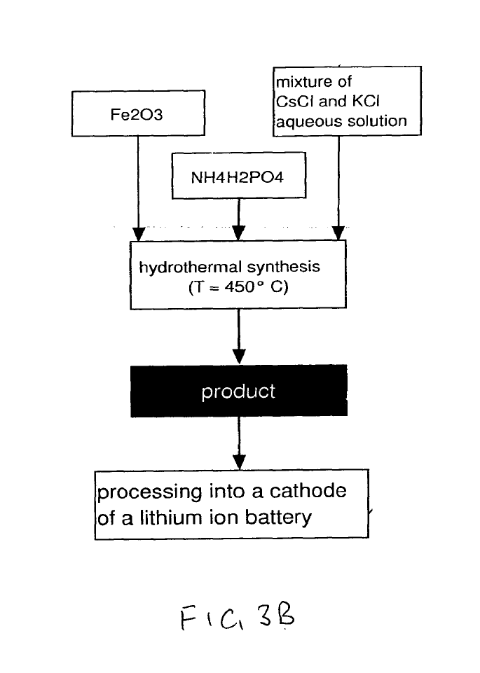

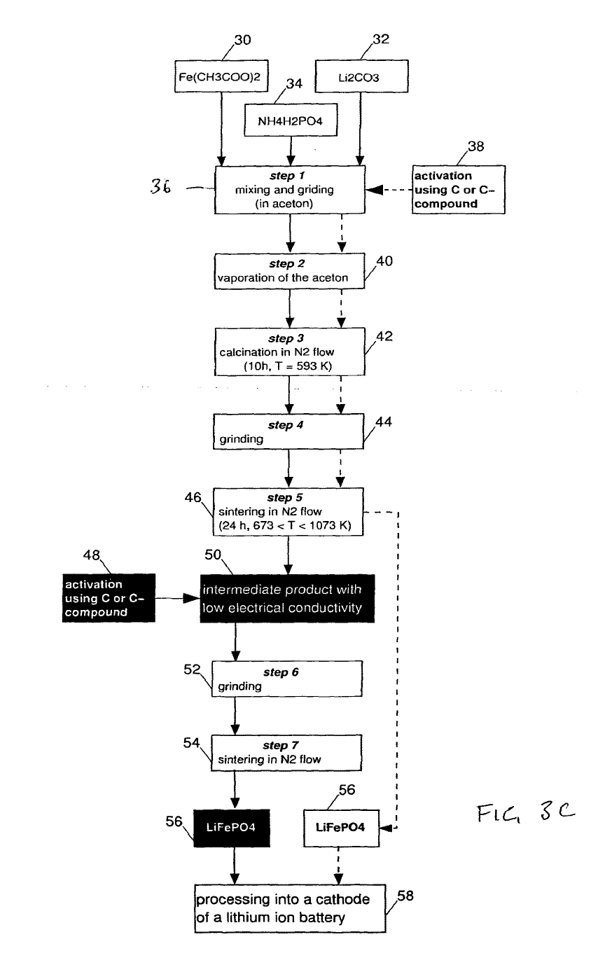

The manufacture of lithium-enriched Arrojadite and the manufacture of LiFePO₄ are fundamentally different. In the case of lithium-enriched Arrojadite a mineral or a synthetic manufactured Arrojadite with a defined chemical composition and defined thermal and structural properties is used as an educt and modified chemically in a two-stage process as illustrated in FIG. 3A or in a one-step process for the synthetic material as illustrated in FIG. 3B, in order to be used, for example, as a cathode material for the lithium ion battery.

As shown in FIG. 3A the starting point for the manufacture of a lithium-enriched Arrojadite material is a naturally occurring mined product symbolised in box 20 which has been cleaned by, for example, flotation as shown by arrow 21 to produce a cleaned mineral as an educt as symbolised in box 22. In this connection the educt Arrojadite is mined as a naturally occurring mineral, for example from corresponding deposits such as the Nickel Plate mine in USA as described in the paper by Lindberg, M. L. with the title “Arrojadite, hühnerkobelite and graftonite” in the Am. Mineral., 35:59-76, 1950.

The product obtained in box 22 then forms the starting product “educt” for the first process step of cation extraction carried out using a suitable complexing agent such as EDTA, acetyl-acetone, 18-crown-6 or dithiozone. This extraction process can be carried out at room temperature (T=293 K) as shown in box 24.

The process step of box 24 is then followed by a second process step illustrated in box 26 in the form of lithium enrichment. This can be done in several ways. For example the material from box 2₄ can be placed in a lithium salt melt for lithium enrichment, e.g. for LiClO₄ the melt temperature is about T=510 K. Alternatively the Lithium enrichment can take place in a suspension of, for example, lithium perchlorate in water, typically at a temperature about T=340K. As a further alternative the insertion of lithium into the open elongate channels can take place in a charge cycle when using the material from process step 24 as an electrode material in a lithium ion battery, for example at room temperature or simply in an electrochemical cell used for this purpose. If the enrichment with lithium takes place by a charge cycle in a cell resembling a lithium ion battery in which the material is used as the electrode then the resulting electrode material of step 24, can be prepared into an electrode for a lithium ion battery, for example by pasting it with a binder on a conductive material.

As an alternative Arrojadite materials can be manufactured synthetically, for example by means of hydrothermal processes as described by Yakubovich, O., Matvienko, E. N., Simonov, M. A, Mellnikov, O. K. entitled “Crystal structure of synthetic Fe³⁺-arrojadite with ideal formula of K₂Na₅Fe²⁺₁₄Fe³⁺(PO₄)₁₂(OH)₂” in Geologiya 41:36-47, 1986. This synthesis is illustrated as a flow diagram in FIG. 3B.

After the synthesis has been completed the material of the invention is present as a crystalline material in an aqueous solution which can be removed leaving the crystalline product with the elongate channels filled with type A exchangeable cations such as Li, Na, K and/or Ag.

When the compound is made by synthesis then it is not treated chemically to remove the exchangeable cations because the exchangeable cations are provided during the hydrothermal synthesis.

At this stage it should be emphasised that lithium is only quoted as an example here for the enrichment step and any other suitable ions, for example, Na, K or Ag could be used in one of the procedures mentioned above.

Thus, using methods of “green chemistry” i.e. avoiding organic solvents the manufacture of lithium-enriched Arrojadite material is a two-stage process which is simple to carry out consisting basically of cation extraction and lithium enrichment. This ability to readily remove the elements filling the channels makes it possible to manufacture the material at very competitive cost and with little technical complexity in air using non-poisonous and favourably priced chemicals which can be manufactured on a large scale technically such as EDTA and lithium perchlorate.

It can readily be seen that the process of manufacturing a suitable Arrojadite material is straightforward and does not involve any serious temperature constraints.

In contrast the manufacture of a conventional LiFePO₁ material is much more complicated as can be seen from FIG. 3C which generally illustrates the manufacture of LiFePO₄ by means of solid state reaction as described by Yamada, A, Chung, S. C., Hinokuma, K in the paper “Optimised LiFePO₄ for lithium battery cathodes” in Journal of the Electrochemical Society 148:A224-229, 2001.

The starting point for this process is to form a mixture of Fe(CH₃COO)₂, Li₂CO₃ and NH₄H₂PO₄ (boxes 30, 32 and 34) and to mix and grind the mixture in acetone (box 36). In order to achieve a sufficient electric conductivity of the material on activation carbon or a carbon-containing compound has to be added, either at this point (box 38) or at a later step in the process chain, box 48.

Thereafter the vaporization of the acetone is effected (box 40) which is followed by calcination in an N2 flow (for 10 h, T=593 K) as indicated in box 42. The product of this process then has to be ground again, as indicated at box 44, prior to a sintering step (box 46) in an N₂ flow (this time for 24 h at a temperature 673<T<1073 K).

If the activation with carbon was not done at the beginning, box 36, the product will not have sufficient electric conductivity and needs to be activated by additional carbon or carbon-containing compounds, box 48. Then the product is ground again (box 52) and subsequently sintered again (box 54) in an N2 flow to obtain the LiFePO₁ material (box 56) which has then to be finally processed into the cathode of a lithium ion battery (box 58).

The lithium enrichment leads with Arrojadite material to an improvement of the electrical conductivity by six orders of magnitude from σ≈3·10⁻¹⁰ S/cm to σ≈4·10⁻⁴ S/cm. The thermal and structural properties are not substantially changed.

In comparison to this the material-typical properties of LiFePO₄ such as for example the chemical composition and the structural layout are strongly dependent on the manufacturing process and ultimately lead to LiFePO₁ materials with different properties.

The lithium enrichment of Arrojadite in the standard process takes place with lithium perchlorate. By isotope marking using lithium-6, whose natural occurrence in the earths crust is 7.5%, it was possible to obtain a direct proof of the successful lithium enrichment in Arrojadite material by means of Li-MAS-NMR solid state spectroscopy.

The changing of individual method parameters within a process stage leads to directly understandable changes in the intermediate product that arises. Thus, for example, the extraction time (stirring time) of the educt in the EDTA solution during the first process step affects its grain size, with the grain size reducing with increasing stirring duration. In the second process step there is likewise a simple and direct linking of the method parameters with the manufactured product. Thus the degree of lithium enrichment is dependent on whether a salt melt or an aqueous suspension of lithium perchlorate and Arrojadite is used for the manufacture of the lithium-enriched material. The highest enrichment was obtained using a suspension of Arrojadite powder and LiClO₄.

In comparison to lithium-enriched Arrojadite material no simple linkage exists with LiFePO₄ between method parameters and manufacturing process and the characteristics of the respectively manufactured product.

The low electrical conductivity of the undoped carbon-free LiFePO₄ material has a negative effect on its use as a cathode material above all on the maximum exploitable capacity and the long term stability of′ such a lithium ion battery.

Various proposals for solving this problem by “activation” of a high ohmic intermediate product in order to manufacture an electrically (highly) conductive cathode material have been published in recent years. In addition to the chemical modification of LiFePO₄ material by doping of the Fe lattice sites and the Li lattice sites, as well as the reaction with carbon (variation of the carbon content), proposals such as the optimization of the solid state reaction (for example the sinter temperature, mechanochemical activation) and the investigation of novel synthesis routes (for example hydro-thermal processes and sol gel processes) have been at the centre of interest.

The activation by carbon-containing compounds or elementary carbon can take place at two points during the manufacturing process, during synthesis of LiFePO₄ or after conclusion in further process steps (FIG. 3C). In dependence on the time of the activation partly differing material properties and side products form. The influence of the side products necessarily formed in dependence on the synthesis route (for example iron phosphide, lithium phosphate and Fe^{III} normal oxide), on the one hand, and the effects of the time point of the addition of carbon or carbon compounds into manufacturing process (activation), on the other hand, have effects on the electrical properties of the LiFePO₄ material and is the subject of numerous discussions in technical literature. These interactions, which have hitherto not been comprehensively researched and documented, between the choice of the synthesis route, the educts that are used and the influence of the carbon material on the properties of the product have wide ranging consequences. No clear association between for example the particle/crystallite size and also the total (in situ) carbon content of the powder, on the one hand, and the capacity of the lithium ion batteries respectively manufactured from them, on the other hand, could be derived from six different commercially manufactured carbon-containing LiFePO₄ powders of different manufacturers.

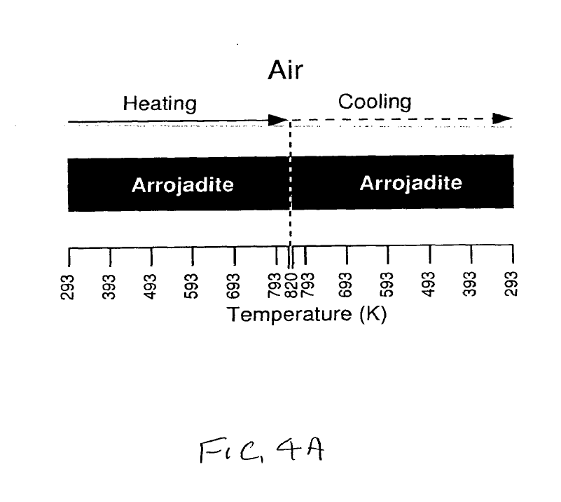

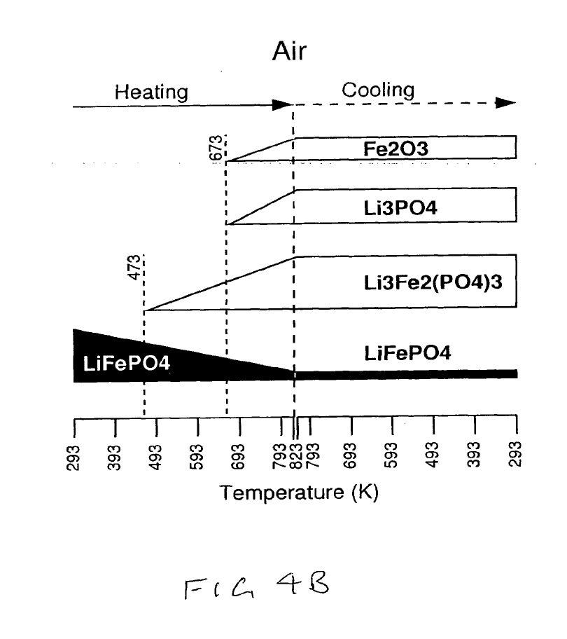

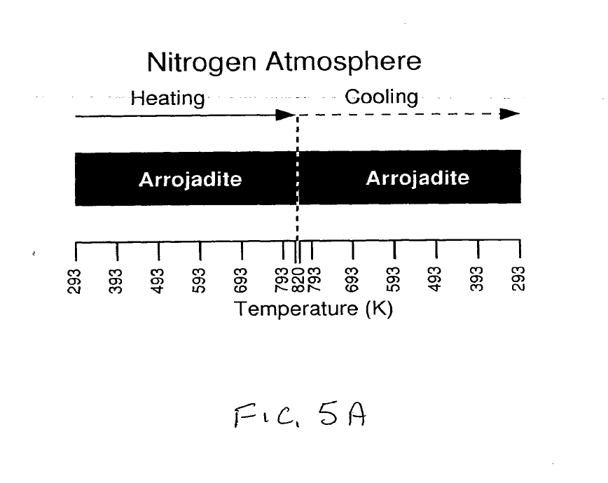

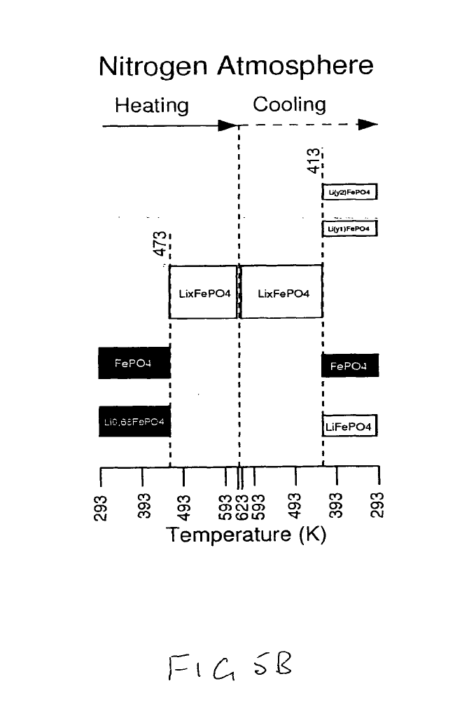

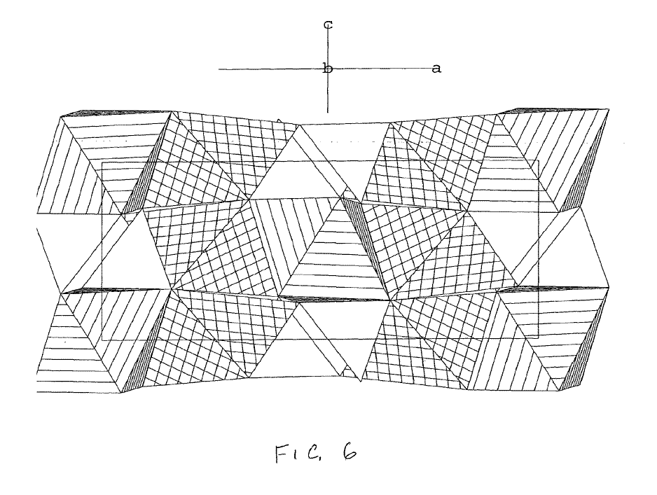

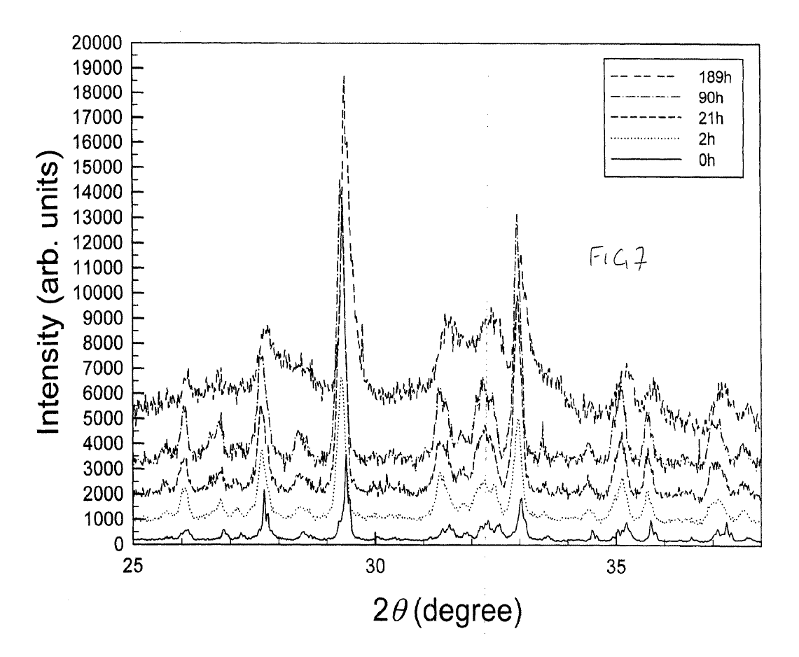

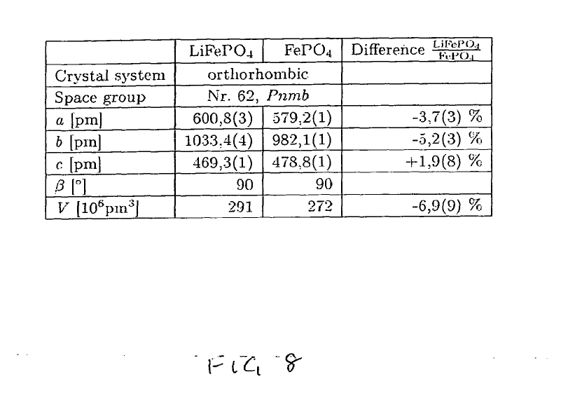

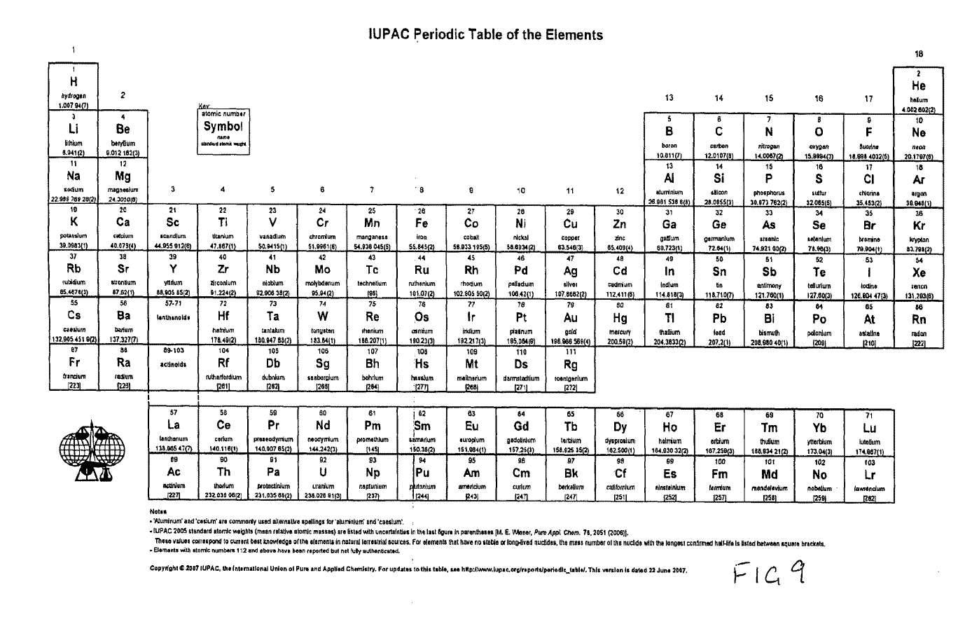

The thermal stability of the two materials Arrojadite and LiFePO₄ is fundamentally different when used in different reactive gas atmosphere (oxidizing, reducing and inert). It is illustrated in FIGS. 4A and 4B for heating in air and in FIGS. 5A and 5B for heating in nitrogen.

The structure of the Arrojadite is maintained both during heating up to a temperature of T≦820K and also during subsequent cooling down to room temperature. This circumstance applies both for oxidizing air and also for an inert gas atmosphere of the nitrogen and has been confirmed by independent experiments using in situ high temperature powder diffraction with synchrotron and X-ray radiation (FIGS. 4A and 5A). The thermal expansion of the material Arrojadite in the temperature range 293K≦T≦733K in the direction of the three crystallographic axes is very small with values for the thermal expansion coefficient

$${a}^{a} \approx {a}^{b} \approx {a}^{c} \approx \frac{1}{K} .$$

The increase of the volume of the unit cell in this temperature range amounts to only ΔV≈0.11%.

In comparison to this the material LiFePO₄ shows a different thermal behaviour. During heating of LiFePO₄ in air in the temperature interval 293K≦T≦823K the material irreversibly decomposes, by the increasing oxidation of the divalent iron contained therein, into a multi-phase system. At T=823K a mixture of amongst other things Li₃Fe₂^{III}(PO₄)₃, Fe₂^{III}O₃ and a small proportion of the educt LiFe^{II}PO₄ is present. This multi-phase mixture is preserved with a luminous bright red colour after cooling down to room temperature (FIG. 4B).

After the first charging and discharging cycle of a lithium ion battery of LiFePO₄ a mixture of LiFePO₄ and FePO₄ is present. During heating (temperature interval 293K≦T≦623K) of a mixture of this kind of Li_{0.68}FePO₄ and FePO₄ in a nitrogen atmosphere (FIG. 5B), heating to above T≧473K leads to the formation of a Li_{X}FePO₄ phase. During heating to temperatures above T≧773K a decomposition of the Li_{X}FePO₄ phase into a plurality of phases takes place. During the cooling process from 623K≧T≧293K a mixture of a plurality of phases is formed when the temperature goes below 413K. These phases have different chemical compositions (LiFePO₄, FePO₄, Li_{y1}FePO₄ and Li_{y2}FePO₄ with y1≠y2 and 0<y1,y2<1) and also slightly differing lattice parameters.

The results of the thermocalorimetric and gravimetric measurements of Arrojadite and LiFePO₄ samples are significantly different. The structural changes on heating Arrojadite samples in different gas atmospheres (air and nitrogen atmospheres) observed in independent experiments using in-situ high temperature powder diffraction with synchrotron and X-ray radiation agree with the results of the differential thermal analysis (DTA). In air the exothermic principle maximum of the DTA curve is in a temperature interval 820K≦K≦890K which is caused by the decomposition of the Arrojadite structure as recorded by means of in situ high temperature powder diffractometry. The powder patterns of the resulting products from the DTA measurements correspond to those obtained by experiments using in situ high temperature powder diffraction with synchrotron or X-ray radiation in the same gas atmosphere. In a reducing forming gas atmosphere a product arises whose lattice constants can be refined from the powder pattern with those of Arrojadite.

In contrast to the simple phase behaviour of the Arrojadite, the thermal behaviour of LiFePO₄ is substantially more complex and is also a subject of current discussion. The observed structural changes during heating and cooling of a mixture of Li_{0.68}FePO₄ and FePO₄ in nitrogen atmosphere can be correlated with the differential thermocalometric experiments carried out in an argon atmosphere: during heating an endothermic maximum (T≈500K) and during cooling an exothermic maximum (T≈410K) occur.

The central difference between the materials Arrojadite and LiFePO₄ is the structural framework. That of LiFePO₄ is shown in FIG. 6 and can be compared with that of Arrojadite as shown, for example, in FIG. 2C. From this comparison significant distinctions result both with respect to the mechanical properties, the thermal stability, the electrical conductivity and the long term stability of lithium ion batteries manufactured from the respective materials and also with respect to the possibility of optimizing the respective material by chemical modification.

Arrojadite has a space frame structure with channels 10 in FIG. 2D extending along the crystallographic b-axis. This places the Arrojadite structure in the area of the zeolites and zeolitex have not hitherto been considered useful for a lithium ion battery for many reasons. The structure of the zeolites is described in the book by Tomlinson A. A. G. Modern zeolites. Structure and function in detergents and petrochemicals. Trans Tech Publications Ltd., Uetikon-Zürich, 1998, ISBN 0-87849-794-0

The occupation of the lattice sites in the channels of the Arrojadite structure forms a basis for the chemical modification of the Arrojadite structure and the use as electroactive cathode material for, for example, a lithium ion battery. The extraction experiments with Arrojadite powder from the “Nickel Plate” mine using an aqueous EDTA solution confirm by experimental routes the occupation of the atomic positions within the channels. A mixed occupation of these atomic positions by the following cations is present: Fe>Na>Mn>Ca>Al>Mg>Zn. The lithium cations in the lithium enriched Arrojadite material move along the corresponding channels 10 opened by the extraction process.

The structure of the Arrojadite is, in contrast to most of the zeolites, despite increasing extraction of the cations from the channels 10 with aqueous EDTA solution so stable that in a time period between 2 and 90 hours extraction duration no changes of the powder pattern relative to the educt can be found in the recorded powder pattern of the respective product. After 189 hours extraction duration nanocrystalline powders have arisen as shown by the powder patterns of FIG. 7. The powder pattern shows reflexes with a full width at half maximum (FWHM) which can be attributed to mechanical reduction during the stirring process. Arrojadite nano-powders can be manufactured also by heating in an oxygen atmosphere under elevated pressure. The characterization of the electrical properties of the material Arrojadite in the form of nano-powders requires further investigation.

In comparison to the Arrojadite material the structure of LiFePO₄ material differs significantly: significantly shorter lattice parameters and smaller unit cell.

In the orthorhombic olivine structure of the LiFePO₄ material the oxygen anions form an approximately hexagonal closest packing with the layer sequence ABAB. The intermediate spaces which result are occupied by the Li⁺, Fe²⁺ and P⁵⁺ cations as shown in FIG. 6. As a result of the arrangement of the Li lattice sites within the orthorhombic olivine structure two different conductive paths for Li cations are possible per unit cell which are perpendicular to each other. In contrast up to eight different conductive paths are present for cations per unit cell of the Arrojadite structure which are all in one direction and therefore their individual conductivities are summed up.

The comparison of the electrical conductivity of the material Arrojadite with that of the material LiFePO₄ results in significant differences. These originate from the different structural properties of the respective material.

The electrical conductivity of pressed powder pellets of Arrojadite shows a pronounced anisotropic behaviour and, in contrast to pellets of LiFePO₄, can be influenced by the choice of the pressing process by the formation of different orientations of the powder particles within the pellet. As a result, without chemical modification of the Arrojadite powder, an electrical conductivity higher by two orders of magnitude can be achieved in comparison to undoped carbon-free LiFePO₄ powder. Texture analyses show that the conductivity paths in the Arrojadite coincide with the channels 10 in the crystal structure. The degree of the lithium enrichment contributes to a further increase of the conductivity of the material Arrojadite, which shows that the conductivity is predominantly based on a lithium ion conduction.

In contrast, the lithium content of the material LiFePO₄ does not influence its electrical conductivity. With LiFePO₄ a significant increase of the conductivity can be achieved by the manufacture of differently doped powders with mixed occupations at the Li lattice sites or by mixed occupation of the Fe lattice sites. The electrical conductivity and the exploitable maximum capacity can be increased through the choice of the corresponding synthesis route using partly organic educts, sinter temperatures which are as low as possible or by the manufacture and use of nano-powders. The influence of the synthesis route on the resulting side products, such as for example iron phosphide, lithium phosphate and Fe^{III} oxide and the associated changes of the properties of the material LiFePO₄ are currently also the subject of discussion.

The direct comparison of the two lithium ion batteries of LiFePO₄ and of Arrojadite illustrates the significant distinctions with respect to the processes which are taking place during respective charging and discharging cycles and the effects associated therewith on the long term stability and the maximum exploitation period for a respective battery.

Both the charging cycle and the discharging cycle of a lithium ion battery of LiFePO₄ is associated with a phase transition of the 1st order LiFePO₄ to FePO₄. This migrates as a zone through each material particle. After the first charge and discharge cycle an initially small proportion of FePO₄ remains which cannot be converted again into LiFePO₄. The concentration of the FePO₄ increases with increasing number of the charge and discharge cycles. The phase transition LiFePO₄ to FePO₄ is also associated with structural changes. For example the length of the lattice parameters and change in size of the unit cell (FIG. 8). The opposing length changes of the lattice parameters Δc≈+2% and Δb=−5.2% and Δa=⁻3.7%), in combination with the volume change of ΔV≈⁻7% leads mechanically to stresses and the increasing formation of dislocations. Both determine as limiting factors the maximum possible number of charge and discharge cycles and the exploitable capacity of a lithium ion battery incorporating the LiFePO₄ material as a cathode material.

In addition the maximum achievable number of cycles without a capacity loss of the order of magnitude of 10%) or more depends on the environmental temperature, i.e. on the temperature of use of this battery type, when T≧25 C.

In comparison to the lithium ion battery of LiFePO₄ in a lithium ion battery of Arrojadite only very small changes of the lattice parameters of the material occur after several thousand charge and discharge cycles. The recorded powder pattern of such a lithium ion battery show with an increasing number of charge and discharge cycles only extremely small changes in the measured powder pattern.

The charge and discharge process of a lithium ion battery on the basis of the material Arrojadite proceeds in accordance with another mechanism than is the case with the material LiFePO₄. The zeolites serve as an example for the manner of operation of a lithium ion battery of Arrojadite material. The zeolites function as an ion exchange medium due to hollow cavities in the form of “cages' and channels within their scaffold structure. These hollow cavities can be reversibly occupied with different cations.

In the manufacture of lithium enriched Arrojadite material a part or all of the cations which are located at lattice sites within the channels 10 of the Arrojadite structure are extracted and replaced by Li cations. In a directly comparable manner to the ion exchange function of the zeolites Li cations occupy with the Arrojadite material the lattice sites within the channels reversibly and in dependence on the state of charge.

In the structural model of the naturally occurring Arrojadite from Nickel Plate the atom oppositions within the channels are occupied by monovalent (e.g. K⁺) and multivalent (Cr³⁺, Fe²⁺ and Fe³⁺) cations. The exchange of the pristine monovalent and multivalent cations results in a maximum enrichable lithium content of approximately 1.8% by weight.

The lithium enrichment by an aqueous suspension of Arrojadite powder and lithium perchlorate achieves with 1.72% by weight approximately 96% on the theoretical value. The remaining inactive charge is due to Na cations of the Na-EDTA solution of the 1st process step that are present.

Using a customary laboratory powder diffractometer no structural changes of the Arrojadite can be measured in dependence on the state of charge of lithium ion battery. The Arrojadite material remains a single phase independently of the state of charge and there is no phase transition with the corresponding structural changes as with LiFePO₄ material.

The capacity of the lithium ion battery of Arrojadite material is almost independent of the number of charge and discharge cycles. This high cycle stability of the material Arrojadite favours the use on a technical scale. The achieved capacity for experimental lithium ion batteries of Arrojadite built to date is still below that of comparable LiFePO₄ batteries on initial charging but it must be borne in mind that the LiFePO₄ batteries have undergone a long period of over ten years optimization. Given further development it should be possible to significantly improve the capacity of batteries using Arrojadite cathodes, so that they are highly competitive with LiFePO₄ batteries on all counts.

The lithium ion battery of Arrojadite material is completely compatible with the modern technology of the lithium ion battery (3.5 V technology) and has, in contrast to cathode materials isostructural to olivine (LiCoPO₄ and LiNiPO₄) the potential for environmentally friendly, cobalt-free and nickel-free, high voltage battery technology (U=5 V).

Examples of uses of the arrojadite material of the invention will now be given in the following:

### Example 1

### Use as a Cathode Material

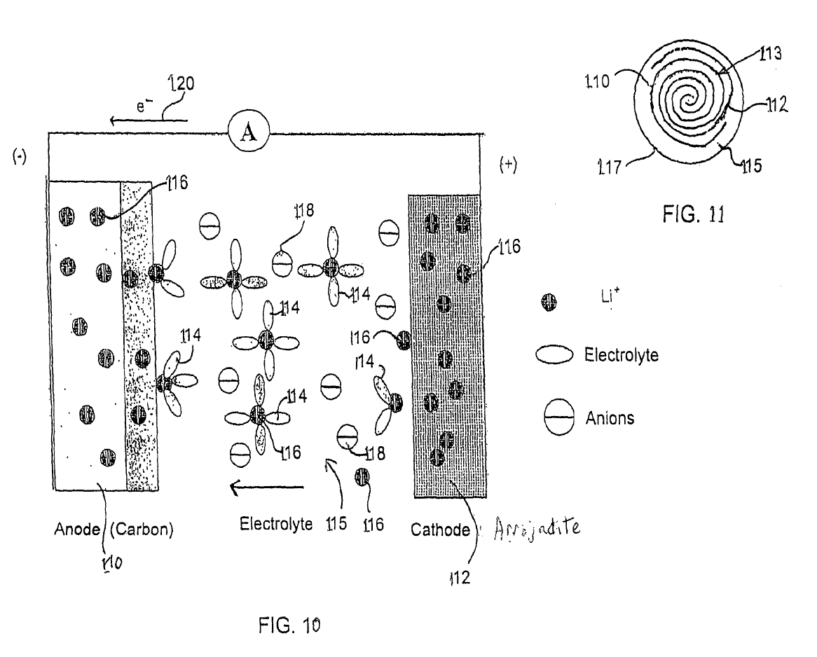

Referring now to FIG. 10 there is shown a diagram showing the basic configuration of a Li-ion battery 100 of a kind used for research. It typically comprises an anode (in this case a lithium anode) 110, a cathode 112, in this case of the material defined in claim 1 of the present application and more specifically with the specific composition set out above for a naturally occurring Arrojadite from the Nickel Plate mine, as described in connection with FIGS. 2A to 2E at the start of the specific description of this application. The cathode material comprises the Arrojadite compound described immediately above which has been ground to a powder with an average particle size of 1 μm. This size is not critical and average particle sizes in the range from 500 nm to 200 μm are also readily possible as are particle sizes below and above this range. The particles used typically have a Gaussian size distribution or a narrower distribution.

The powder is mixed with a binder, in this case polyvinyl difluoride (PVDF), at a weight ratio of nine parts arrojadite material to one part of PVDF and is then pasted onto an electrically conductive foil, in this example a copper foil of say 99.6% purity available from Goodfellow. Neither the binder material, nor the weight ratio nor the material of the conductive foil is critical.

The lithium electrode, i.e. the anode, 110 is, for example, a pure lithium foil available from Aldrich.

An electrolyte 114 is disposed in the space between the anode 110 and the cathode 112. The electrolyte can be any known electrolyte for a lithium ion battery and in this case is an electrolyte in the form of a solution of 1M LiPF₆ in ethylene carbonate (EC)/dimethyl carbonate (DMC) in the ratio 1:1 by volume obtained from Ube industries Ltd., which is accommodated in a glass fibre separator such as GF/D from Whatman.

This is only one example of a whole range of possible electrolytes. Present throughout the volume of the electrolyte 115 are also lithium ions 116 shown as circles with a cross in the middle, and anions 118 shown as larger circles with a single line through the middle. When an external circuit is connected to the battery, current flows in the direction opposite to the arrow 120 during discharging and in the direction of the arrow during charging.

The cell of FIG. 10 is accommodated in a casing (not shown).

### Example 2

### Use as a Cathode Material

This example is the same as Example 1 but uses a carbon material as an anode in place of lithium. The anode material can be in the form of a solid piece of graphite or powdered carbon in a binder. The carbon powder has an average particle size of 2 μm and is mixed with a binder in the form of PVDF at a weight ratio of nine parts of carbon material to one of binder and is pasted on an electrically conductive foil, in this case an aluminium foil. Again neither the size of the particles, nor the material of the bindee, nor the type of foil are critical. Thus a copper foil of 99.6% purity from Goodfellow could again be used here instead of the aluminium foil.

### Examples 3 and 4

Examples 3 and 4 are generally the same as examples 1 and 2 except that an electrolyte is used consisting of a polymer material with lithium ion salts in dissolved or particulate form such as LiPF₆ rather than LiPF₆ in EC/DMC as described for Examples 1 and 2.

### Example 5

### Use of Arrojadite Material as an Anode

Alternatively the anode 110 can be made of the material defined in claim 1 of the present application and more specifically with the specific composition set out in the above description, more specifically with the specific composition set out above for a naturally occurring Arrojadite from the Nickel Plate mine, as described in connection with FIGS. 2A to 2E at the start of the specific description of this application. In this case the cathode 112 could for example consist of the lithium electrode, for example a pure lithium foil available for Aldrich. The electrolyte 114 can be any known electrolyte for a lithium ion battery as described above in examples 1-4. The electrical connections to the power supply, in case of example 5, is the reverse of that used in examples 1-4.

Reference should now be made to FIG. 11 which shows an alternative lay-out for a battery where the electrodes 110 and 112 are coiled in a spiral 113 with the electrolyte 115 disposed between them and the structure being encapsulated in a housing 117. Terminals connected to the anode 110 and the cathode 112 are provided at opposite ends of the housing (terminals not shown) in manner known per se. The same layout as shown in and described with reference to FIG. 11 can be used for a supercapacitor.

The materials can be the same as those described with reference to FIG. 10.

### Examples 6 to 9

These examples are the same as examples 1 to 4 given above except that the electrolyte used is one used and claimed in European patent 1505680B1. One example for the preparation of non-aqueous, anhydrous electrolytes given in that European patent is as follows:

The composite electrolyte was prepared in the form of a mixture of fine particles of ceramic oxides (SiO₂, TiO₂ and Al₂O₃, radius: r˜0.15 μm) with a non-aqueous solution of 0.1M LiClO₄ in Methanol (MeOH). Although MeOH was selected for this test it is not a preferred solvent for lithium batteries. However, because the method is effective using MeOH it appears certain that it will work better in the preferred solvents, i.e. in a non-aqueous, anhydrous solvent selected from the group comprising DME/EC, DEC/EC, DMC/EC, PC, carbonate based solvents related to any of the foregoing, DMSO, organic sulphur compounds, THF, AN and mixtures of any of the foregoing, and indeed practical tests have confirmed this.

In this example the oxides were dried in vacuum at 250° C. for 24 hours prior to composite preparation and all samples were prepared under an Argon atmosphere in a glove box (closed container with a window and gloves for handling the materials involved). Room temperature conductivity was measured for various volume fractions using impedance spectroscopy with the samples placed between two parallel stainless steel electrodes of a home-built cell (samples loaded under Argon). The impurity effects were excluded by pre-washing the oxides in the liquid solvents. The conductivity was better than 2·10⁻³ S/cm.

When used in a lithium ion battery an electrolyte of this kind does not require a separator.

### Examples 10 to 13

In another alternative electrolyte a non-aqueous electrolyte is used including
at least one ionically conducting salt,
at least one non-aqueous, anhydrous solvent for the ionically conductive salt, and
at least one oxide in a discrete particulate form having particles sizes in the range from 5 nm to 50 nm and comprising an oxide selected from the group of oxides exhibiting acidic properties, SiO₂, TiO₂, oxides exhibiting basic properties, Al₂O₃, MgO, mesoporous oxides, clays and any mixtures thereof, said oxide being present in the electrolyte in an amount by volume in the range from 0.005 to 0.2%, said oxide being selected such that it is not soluble in said solvent and such that it is water-free.

The solvent is a compound according to the general formula (I):

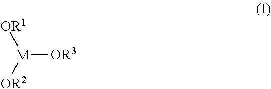

or a mixture of compounds of this kind
wherein:
M is selected from the group consisting of boron and aluminum,
and
R¹, R² and R³, independently from each other, are selected from the group consisting of alkyl, alkenyl, alkinyl, aryl, aralkyl, alkoxy, alkenyloxy, cycloalkyl, cycloalkenyl, cycloalkoxy, cycloalkenyloxy, aroxy, aralkoxy, alkylaroxy, cyanoalkyl, cyanoalkenyl, cyanoalkoxy, hydroxyalkyl, hydroxyalkenyl, hydroxylalkinyl, hydroxyaryl, hydroxyaralkyl, hydroxyalkoxy, hydroxyalkenyloxy, hydroxycycloalkyl, hydroxycycloalkenyl, hydroxycycloalkoxy, hydroxycycloalkenyloxy, hydroxyaroxy, hydroxyaralkoxy, hydroxyalkylaroxy, hydroxycyanoalkyl, hydroxycyanoalkenyl, hydroxycyanoalkoxy, halogenated alkyl, halogenated alkenyl, halogenated alkinyl, halogenated aryl, halogenated aralkyl, halogenated alkoxy, halogenated alkenyloxy, halogenated cycloalkyl, halogenated cycloalkenyl, halogenated cycloalkoxy, halogenated cycloalkenyloxy, halogenated aroxy, halogenated aralkoxy, halogenated alkylaroxy, halogenated cyanoalkyl, halogenated cyanoalkenyl, halogenated cyanoalkoxy, halogenated hydroxyalkyl, halogenated hydroxyalkenyl, halogenated hydroxylalkinyl, halogenated hydroxyaryl, halogenated hydroxyaralkyl, halogenated hydroxyalkoxy, halogenated hydroxyalkenyloxy, halogenated hydroxycycloalkyl, halogenated hydroxycycloalkenyl, halogenated hydroxycycloalkoxy, halogenated hydroxycycloalkenyloxy, halogenated hydroxyaroxy, halogenated hydroxyaralkoxy, halogenated hydroxyalkylaroxy, halogenated hydroxycyanoalkyl, halogenated hydroxycyanoalkenyl, halogenated hydroxycyanoalkoxy residues, ether group containing residues, thiol group containing residues, silicon containing residues, amide group containing residues and ester group containing residues.

More specifically the solvent used in the Examples 10 to 13 is a solvent according to the general formula (I) containing a lithium salt.

The at least one ionically conducting salt is a lithium salt and may, for example, be any salt selected from the group consisting of LiCl, LiF, LiSO₃CF₃, LiClO₄, LiN(SO₂CF₃)₂, lithium-bis[oxalato]borate (LiBOB), LiPF₆ and LiN(SO₂CF₂CF₃)₂.

The ionically conducting salt is dissolved in the solvent in a concentration of about 1 M and the specific oxide used in these examples 10 to 13 is 0.005% by volume. The average particle size of the at least one oxide in a particulate fowl is typically 20 nm. The resulting electrolyte has a lithium transference number of 0.65 but a value anywhere between 0.5 and 0.75 is acceptable.

Other conventional electrolytes which are well known per se can also be used. However, such other electrolytes generally require a suitable separator and these are well known per se.

### Example 14

### Use as a Separator

The material of the present invention is also particularly suited for use as a separator, for example in a molten salt cell such as the Zebra cell. This is a battery with a positive electrode of nickel in the discharged state and nickel chloride in the charged state. The negative electrode is molten sodium. The electrolyte is molten chloroaluminate (NaAlCl₄). In this case a separator based on the material claimed here is used instead of the traditional sodium conducting β-alumina ceramic separator and the open elongate channels in the separator of the present teaching serve for the transport of sodium ions during charging and discharging of the battery.

For a more complete description of a Zebra battery reference can be made to the paper by J. L. Sudworth entitled “Zebra batteries” in the Journal of Power Sources, 51 (1994) 105-114, the content of which is incorporated herein by reference.

The precise crystallographical structures for the Arrojadite minerals from the Nickel Plate and Hagendorf mines will now be recited in CIF format.

1-18. (canceled)

19. Use of a phosphate based compound as an electroactive material, the phosphate based compound comprising:
A: extractable cations used in charging and discharging and being at least one of Li, Na, K and Ag,
wherein up to 25 Mol-% of the compound may be present in each of the following categories:
elements of Group 1 of the periodic table of elements,
elements of Group 2 of the periodic table of elements,
elements of Group 13 of the periodic table of elements,
elements of the group of transition metals, Groups 3-12 of the periodic table of elements,
elements of Group 14 of the periodic table of elements,
B: non-exchangeable cations from the transition metals,
wherein 9 Mol-%-23 Mol-% of the compound may be present in each of the following categories:
elements of Group 1 of the periodic table of elements,
elements of Group 2 of the periodic table of elements,
elements of Group 13 of the periodic table of elements,
elements of the group of transition metals, Groups 3-12 of the periodic table of elements,
elements of Group 14 of the periodic table of elements,
C: 60 Mol-%-90 Mol-% of the compound is anionic in the form of phosphate (PO₄)³⁻ anions, where oxygen is or may be partially substituted by a halide and/or OH⁻ to a maximum concentration of 10 Mol-% of the oxygen of the anions,
wherein said phosphate (PO₄)³⁻ anions may be partially substituted by one or more of:
SiO₄⁴⁻ silicate,
BO₃³⁻ borate,
CO₃²⁻ carbonate,
H₂O water
up to a maximum amount of <31 Mol-% of the anions,
said compound being in crystalline form and having open elongate channels extending through the unit cell of the structure and
with the compound being present either in single crystal form or as an anisotropic microcrystalline or nanocrystalline material so as to serve as an electroactive material in use.

20. Use in accordance with claim 19, wherein said compound in crystalline form has been treated to remove said extractable cations to leave open elongate channels extending through the unit cell of the compound, said elongate channels optionally being subsequently filled with a desired species of cation.

21. Use in accordance with claim 19, wherein the compound additionally consists of at least one element selected from the group consisting of Group 2 of the periodic table of elements and aluminum.

22. Use in accordance with claim 19, wherein the element selected from the group of transition metals, Groups 3-12 of the periodic table of elements, comprises at least one of Sc, Ti, V, Cr, Mn, Fe, Co, Ni, Cu and Zn.

23. Use in accordance with claim 19, wherein the electroactive material is used as an electrode material such as a cathode for a primary or secondary battery, or as an anode for a primary or secondary battery or in another form of electrochemical storage device.

24. Use of a compound in accordance with claim 19 as an electroactive material in an electronically insulating form, e.g. as a semipermeable membrane used as a separator in an electrochemical cell or a battery.

25. Use of a compound in accordance with claim 19 as an electroactive material in the form of an anode for a primary or secondary battery.

26. Use in accordance with claim 23 wherein, in a lithium battery, the element selected for the exchangeable cations is Li, or, in a sodium battery, the element selected for the exchangeable cations is Na, or, in a potassium battery, the element selected for the exchangeable cations is K, or, in a silver battery, the element selected for the exchangeable cations is Ag.

27. An ion exchange material comprising the phosphate based compound of claim 19.

28. A method of preparing a phosphate based compound in accordance with claim 19 comprising the steps of:
removing from the earth in a suitable location, e.g. the Nickel Plate mine in South Dakota, USA, or the Hagendorf mine in the Oberpfalz, Bavaria, Germany, a naturally occurring compound having the chemical composition of claim 19 together with impurities,
purification of the naturally occurring compound to remove the impurities, and
chemically treating the naturally occurring compound, preferably after purification, to remove, so far as possible, mobile cations of the type A and the naturally occurring impurities to clean the open elongate channels extending through the unit cell of the structure.

29. A method in accordance with claim 28 wherein said purification process comprises a flotation process.

30. A method of preparing a phosphate based compound in accordance with claim 19, wherein the compound is made by synthesis and is chemically treated to remove an element forming exchangeable cations, for example Li, Na, K, Ag and/or Al to unload or clean the elongate channels extending through the unit cell of the structure.

31. A method in accordance with claim 30 wherein said synthesis:
is a hydrothermal synthesis, carried out using:
B: non-exchangeable cations, e.g. in the form of an oxide of one or more transition metals, group 3-12 of the periodic table of elements, e.g. Fe₂O₃,
C: anions in the form of a phosphate, e.g. (NH4)₂HPO₄ or (Na,K)₂HPO₄,
A: exchangeable cations as a soluble salt of one of Li, Na, K and Ag, e.g. KCl, the method being carried out in a pressure vessel in the presence of water in a temperature range of 300° C.-600° C., e.g. 450° C., with the initial concentration of the aqueous solution being selected so that the concentration of type A cations, e.g. KCl, amounts to 30-70 wt %, preferably to about 50 wt %, and with CsCl being present in an amount of 70-30 wt %, preferably e.g. 50 wt %.

32. A method in accordance with claim 28, wherein said chemical treatment step is carried out using a complex forming agent, e.g. EDTA (2-[2-(Bis(carboxymethyl)amino)ethyl-(carboxymethyl)amino]acetic acid), pentan-2,4-dion (acetyl-acetone), crown-ethers e.g. 18-crown-6, or 1,5-diphenylthiocarbazon (dithizone).

33. A method in accordance with claim 28 and including the further step of at least partially filling the open elongate channels with an active element selected from Group 1 of the periodic table of elements, e.g. Li, Na, K and Ag.

34. A method in accordance with claim 33, wherein said filling step is carried out by a chemical process, e.g. by immersing the said compound in a salt melt, preparing the said compound in suspension or electrochemically.

35. An electroactive crystalline material in the form of a phosphate based compound having a structure comprising:
A: exchangeable cations used in charging and discharging,
B: non-exchangeable cations of one or more of the transition metals,
C: 60 Mol-%-90 Mol-% of the compound being present in the form of phosphate (PO₄)³⁻ anions, where oxygen is optionally partially substituted by a halide and/or OH⁻ to a maximum concentration of 10 Mol-% of the oxygen of the anions and wherein said (PO₄)³⁻ coordination polyhedra may be partially substituted by one or more of:
SiO₄⁴⁻ silicate,
BO₃³⁻ borate,
CO₃²⁻ carbonate,
H₂O water up to a maximum amount of <31 Mol-% of the anions,
said compound being in crystalline form and having at least one open elongate channel extending through the unit cell of the structure or a channel filled with one species of exchangeable cation and
with the compound being present either in single crystal form or as an anisotropic microcrystalline or nanocrystalline material.

36. Use of a compound in accordance with claim 19 as an electronically insulating material, e.g. as an electrolyte in an electrochemical cell or a battery.

37. Use in accordance with claim 19, wherein the compound is a natural crystalline form and the elongate channels are treated to remove impurities therein.

38. Use in accordance with claim 37, wherein the elongate channels are treated using a flotation process.
